(19) United States
(12) Patent Application Publication
(10) Pub. No.: US 2012/0096369 A1
(43) Pub. Date: Apr. 19, 2012

(54) AUTOMATICALLY DISPLAYING PHOTOS UPLOADED REMOTELY TO A DIGITAL PICTURE FRAME

(75) Inventor: Geoffrey Howard Nudd, San Francisco, CA (US)

(73) Assignee: ClearCare, Inc., San Francisco, CA (US)

(21) Appl. No.: 13/277,146

(22) Filed: Oct. 19, 2011

Related U.S. Application Data
(60) Provisional application No. 61/394,676, filed on Oct. 19, 2010.

(51) Int. Cl. G06F 3/01; G06F 15/16

(52) U.S. Cl. 715/748

(57) ABSTRACT

Provided is novel computer enabled approach for loading pictures on to a digital picture frame, or on to a computer system functioning as a digital picture frame, via an Internet interface. The digital picture frame operates according to software instructions that when processed by a microprocessor or the like, downloads pictures over the Internet from using data storage software and displays them. In one embodiment, the digital picture frame, being an Internet-connected device with a processor capable of executing a variety of software programs and displaying images on a monitor, preferably including a touch screen input interface (ex. a “tablet” such as an Apple iPad), is used as part of a healthcare system for in-home healthcare providers. When the system is not being used for the provision of healthcare, it can display photos and videos which have been uploaded by the family and friends of the patient.

### RELATED APPLICATIONS

This application claims priority to U.S. Provisional Application Ser. No. 61/394,676 filed Oct. 19, 2010 and entitled System and Apparatus for Automatically Displaying Photos Uploaded Remotely to a Digital Picture Frame, which is hereby incorporated herein by reference in its entirety.

### BACKGROUND OF THE INVENTION

Digital picture frames have emerged in recent years as a popular way to view digital photographs. A variety of digital picture frame models are sold by various manufacturers such as Digital Spectrum's Memory Frame MF-801, Ivepo's Kaleido R7, Pandigital's PAN7000DW, HP's DreamScreen 100, and Philips SFP3010C/G7.

Additionally, products such as the Apple iPad can be configured to digitally display pictures. However, as Consumer Reports notes in an article written on Apr. 19, 2010, it is difficult to get images into the iPad. The author, Terry Sullivan writes, “The biggest difficulty I encountered was getting images into the iPad.” Embodiments of the invention described herein address this problem.

Moreover, a great many social networks such as Facebook.com and MySpace.com have grown very rapidly, in part based on the desire of consumers to share photographs with friends and family. Facebook claims over 500 million active users as of October 2010, with over 250 million logging in each day. Embodiments of the invention described herein provide a new way for friends and families to share photos.

Other problems that are addressed by embodiments of the invention described herein are that of social isolation and use of a digital picture frame by a person with limited technical capability and knowledge. By way of example, senior citizens often feel isolated from their friends and family and sometimes have limited technical capabilities in their use of computers.

A digital picture frame, by displaying photos of friends and family, can help senior citizens feel connected. However, there is presently no automatic means for persons with limited technical capabilities to load photos to their digital picture frame without interacting with the digital picture frame at its physical location, and no automatic and user-friendly ways for friends and family to load their pictures to another person's digital picture frame as means of achieving social connectedness. As described herein, the invention addresses these problems in an elegant manner.

### BRIEF DESCRIPTION OF THE DRAWINGS

Various embodiments embodying invention are illustrated by way of example, and not by way of limitation, in the figures of the accompanying drawing and in which like reference numerals refer to similar elements and in which:

FIG. 1 is a flow diagram 100 that illustrates a computer-enabled system and apparatus for automatically displaying photos uploaded remotely over the Internet to a digital picture frame.

FIG. 2 is a flow diagram 200 that illustrates a computer-enabled system and apparatus for automatically displaying photos uploaded remotely to a digital picture frame via a peer-to-peer, 3G and/or other protocols.

FIG. 3 is a wireframe diagram that illustrates the interface of a web-based portal for a healthcare information system which provides tracking and management of patient care, a photo storage service, and which facilitates the automatic display of photos which are uploaded via the web-based portal to a digital picture frame.

FIG. 4 and FIG. 5 are wireframe diagrams that illustrate interfaces for caregivers and their patients which are part of the healthcare information system described herein, and which are preferably displayed on a touch screen tablet (by way of example, an Apple iPad) which is used by a caregiver to manage and document care tasks, and which also functions as a digital picture frame when not in use by the caregiver or other users.

FIG. 6 is a flow diagram 600 that illustrates a computer-enabled system and apparatus for automatically displaying photos uploaded remotely to a shared photo repository to one or more digital picture frames.

FIG. 7 is a block diagram that illustrates the communication of entities via Internet connections for the transmission of digital photographs for display on a digital picture frame, storage on a photo storage service and/or shared photo repository, ordering of photos for hard copy printing, and/or for the transfer of payment information.

FIG. 8 is an example of a computer system embodying an interface program according to one embodiment.

### DETAILED DESCRIPTION

A computer-enabled method is provided for automatically displaying photos uploaded remotely to a digital picture frame. In the following description, for the purposes of explanation, specific details are set forth in order to provide a thorough understanding of the invention. However, it will be apparent that the invention may be practiced without these specific details. In other instances, well-known structures and devices are depicted in block diagram form in order to avoid unnecessarily obscuring the invention. Specific systems and methods described herein utilize a memory controlled by a processor or logic array, where the memory may be constructed with various memory devices, such as flash memory devices or RAM (random access memory) that may or may not be block oriented. The systems and methods described herein do not differentiate between Flash memory, RAM or other types of memory, and further envision new types of memory developed in the future that will utilize various embodiments described herein. The described systems and methods may utilize any type of memory device, regardless of the specific type of memory device shown in any figures or described herein.

According to one embodiment, an apparatus and computer-enabled system implemented by software is provided for loading pictures on to a digital picture frame, or on to a computer system functioning as a digital picture frame, via an Internet interface. Pictures are uploaded to an Internet website via means well known to those skilled in the art, and are thereafter stored digitally on data storage hardware. The pictures may be designated by the user via the web interface to be in turn transmitted to the digital picture frame over the Internet, or may be automatically designated for transmission to the digital picture frame over the Internet by virtue of having been uploaded to the Internet website. The digital picture frame, per software instructions which operate it, downloads pictures over the Internet from the data storage software, and displays them. The pattern and/or order of display of the photos, the period at which photos are downloaded from the website, and other parameters may be set by users and/or by software default settings.

In another embodiment, the digital picture frame, being an Internet-connected device with a processor capable of executing a variety of software programs and a monitor, preferably including a touch screen input interface (ex. a “tablet” such as an Apple iPad), is used as part of a healthcare system for in-home healthcare providers. According to event criteria that may be designated by the user or an administrator, or which may be preset in software, the tablet downloads photos over the Internet from a photo storage repository. Similarly, according to event criteria that may be designated by the user or an administrator, or which may be preset in software, the tablet variably displays the aforementioned photos, the interface for a healthcare system, and/or interface for other software program(s). This invention enables family and friends of a senior citizen to easily share photos with the senior citizen using a tablet which also serves as part of an in-home healthcare system.

In another embodiment, via a web interface, a user can designate photos which have been uploaded and posted to a photo storage website, such as Facebook, MySpace, or Shutterfly, to be downloaded and displayed by a computer system functioning as a digital picture frame. In a related embodiment of the invention, if the photo storage website designates permissions by which a group has access to photographs and other shared materials and information that are otherwise not accessible by users that are not members of the group (by way of example, “Facebook Groups”), the aforementioned group permissions can be used to determine which users can download and display digital pictures to their digital picture frame(s) in accordance with the invention.

In another embodiment, a photo may be purchased from the computer system functioning as a digital picture frame. In one embodiment, a user may touch the screen of a digital picture frame when it displays a photo, and this event triggers the display of a purchase interface that enables the user to purchase the photo. In another embodiment, purchasing data including but not limited to the user's shipping address, payment means, billing address, and other data is stored on a database, and a user may make a request via the digital picture frame for purchase of one or more photos which is transmitted to the photo storage service, and which in turn triggers a purchase and a series of steps well-known to those skilled in the art to fulfill the purchase of the one or more photos.

In another embodiment, payment is distributed to one or more parties when a photo is purchased from the computer system functioning as a digital picture frame. The one or more parties to which payment is distributed may include but are not limited to the provider of the photo storage website, such as Facebook or Shutterfly, the provider of software which enables photos to be downloaded by the computer functioning as a digital picture frame and/or which enables ordering of photos via the digital picture frame, and/or a fulfillment company(s) that prints and/or ships the photos.

In another embodiment, a machine readable medium is provided containing instructions that, when executed by one or more processors, perform operations of providing an interface to a remote digital display device having a visual display, an device processor and memory configured to display one or more media programs for viewing on the digital display device and sending a media program from another location with the interface via a computer network system to automatically display on the remote display device with the device processor and memory. The remote display device includes a display application configured to display received photos on the visual display, which may be a screen saver application configured to display media programs on the visual display when it is not in use by a user. The media program may include one of photos, advertisements and video programs.

In another embodiment, a system for displaying digital photos on a digital picture frame used for the management of healthcare is provided having a portable display device configured for the display of digital media programs and for the management of healthcare and a computing device configured to communicate with the portable display device having an interface by which photos may be designated for transmission to the display device.

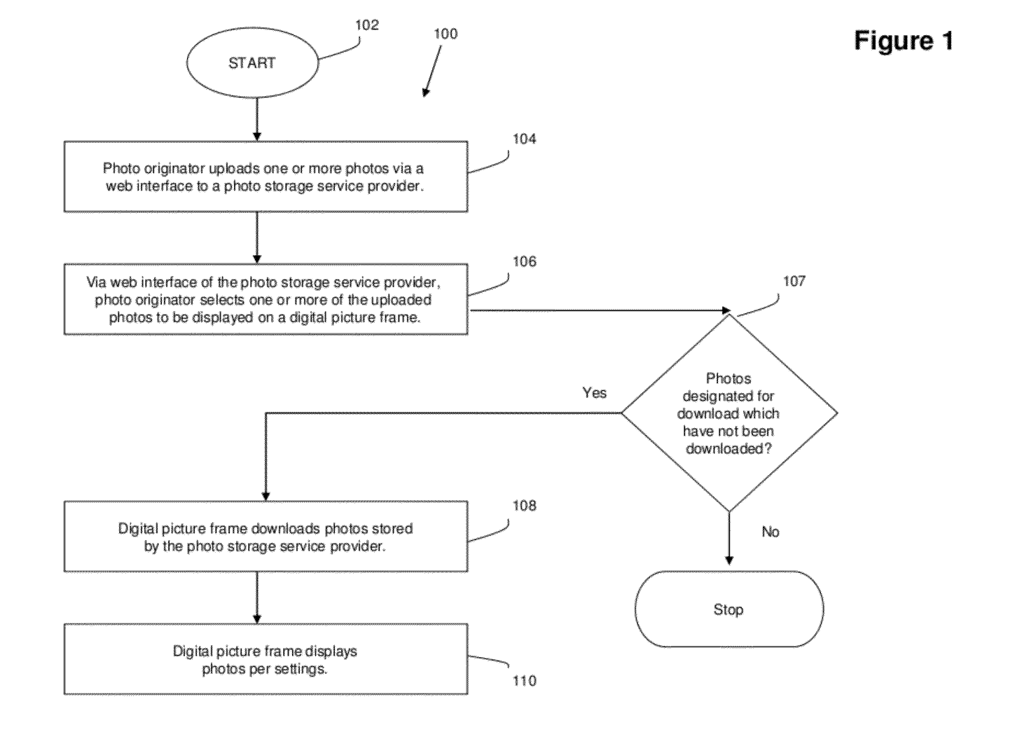

Referring now to the figures, FIG. 1 is a flow diagram 100 that illustrates one example of a computer-enabled system and apparatus for automatically displaying photos uploaded remotely to a digital picture frame. According to one embodiment of the invention, starting from step 102, in step 104, a person in possession of a digital photo stored on a local computer (the “photo originator”) uploads one or more photos via a web interface wherein the photos are transmitted over the Internet and stored on a database of a photo storage service provider. The methods and systems for the upload of one or more photos to a photo storage service provider are well-known to those skilled in the art. Photo storage service providers which enable this functionality include Shutterfly, SmugMug, Flickr and Facebook.

In step 106, the photo originator designates one or more of the photos that were uploaded in step 104 to be displayed on the digital picture frame. One method for designating the one or more photos is via a web interface of the photo storage service provider wherein the photo originator checks a box or otherwise provides an input via the web interface to indicate whether or not the photo is to be displayed and/or downloaded by the digital picture frame. In another embodiment, in step 106, photos are selected for download and/or display via selections made by the user on the digital picture frame. In another embodiment, in step 106, a photo is automatically downloaded and/or displayed by the digital picture frame based on the criterion that the photo is stored by the photo storage service provider, or on the criterion that the photo is stored in a specified storage location or directory of the photo storage service provider. This criterion has the advantage of simplicity whereby a user wishing to display a photo on the digital picture frame only must upload the photo to the photo storage service or to the specified storage location or directory of the photo storage service in order for it to be displayed. In another embodiment, a photo is automatically deleted and/or not displayed by the digital picture frame if the photo is deleted from the photo storage service provider.

In one embodiment, in step 107, a determination is made as to whether there are one or more photos stored by the photo storage service provider which meet the criteria that they (1) have not been downloaded by the digital picture frame, and (2) are designated to be downloaded by the digital picture frame. The fulfillment of these criteria triggers the download of the one or more photos by the digital picture frame from the photo storage service provider over the Internet in step 108.

In another embodiment, in step 107, the digital picture frame or system functioning as a digital picture frame periodically sends a signal to the photo storage service provider which triggers a query to determine whether or not there are one or more photos which have not been downloaded by the digital picture frame, but which are designated to be downloaded by the digital picture frame, and in the event that there are such photos, triggers the download of the photos to the digital picture frame in step 108.

In step 110, the digital picture frame displays one or more of the photos which have been downloaded, wherein the display of the one or more of the photos is controlled by settings. In one embodiment, there is a default setting by which any photos uploaded from the photo storage service provider are automatically periodically displayed via the digital picture frame. In another embodiment, the owner of the digital picture frame is prompted via the digital picture frame interface to choose whether or not to display the photo after a new photo has been uploaded to the photo storage service. In another embodiment, the owner of the digital picture frame can log-in to the photo storage service and confirm and designate whether or not one or more photos which has been designated by the photo originator for display in the digital picture frame is to be downloaded and/or displayed by the digital picture frame. Settings that may be adjusted on the digital picture frame and/or via the photo storage service provider and/or via other means may include, but are not limited to, the pattern and/or order of display of the photos, the period at which photos are downloaded from the website, the size of the photos as they are displayed, the pattern by which they are scrolled or otherwise enter and exit the display on the digital picture frame, and/or other parameters.

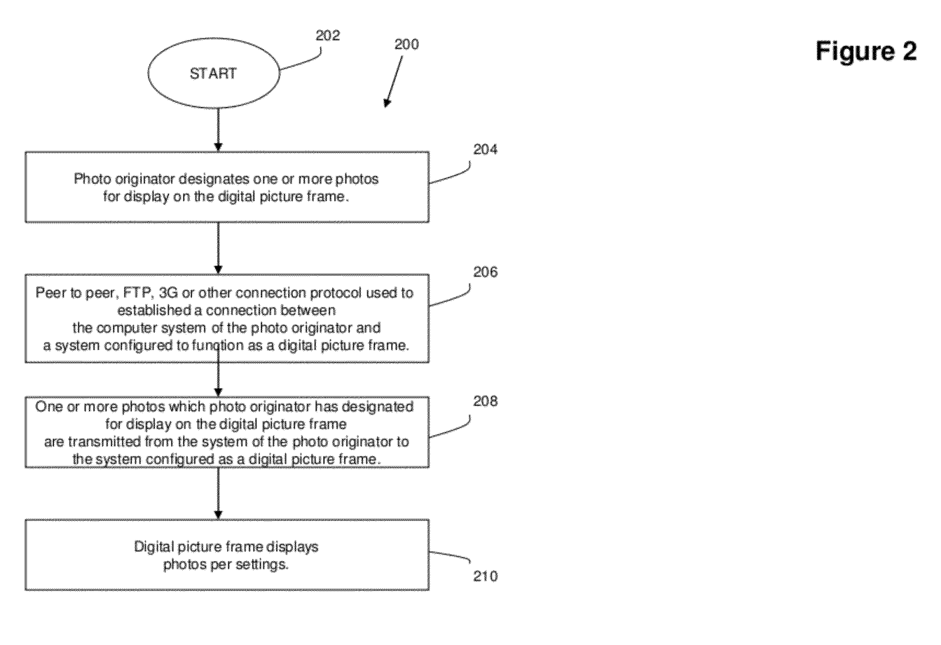

Referring to FIG. 2, a flow diagram 200 illustrates one example of a computer-enabled system and apparatus for automatically displaying photos uploaded remotely to a digital picture frame via a peer-to-peer, 3G, file transfer protocol (FTP), or other connection protocol well-known to those skilled in the art by which one computer system can transmit information to another computer system.

Starting with step 202, a photo originator designates one or more photos for display on a digital picture frame in step 204. In one embodiment, a software program stored on the computer of the photo originator enables the photo originator to view photos which are stored on the computer and to designate the one or more photos. In step 206, a connection is established between the computer system of the photo originator and the system configured to function as a digital picture frame. It should be noted that the creation of the connection in step 206 does not necessarily need to be performed after the designation of photos in step 204.

In step 208, one or more photos which the photo originator has designated for display on the digital picture frame is transmitted from the system of the photo originator to the system configured as a digital picture frame according to one or more of the aforementioned connection protocols, or other protocols that may be used to facilitate the transmission of information that are well known to one skilled in the art. In step 210, the digital picture frame displays one or more of the photos which have been downloaded, wherein the display of the one or more of the photos is controlled by settings.

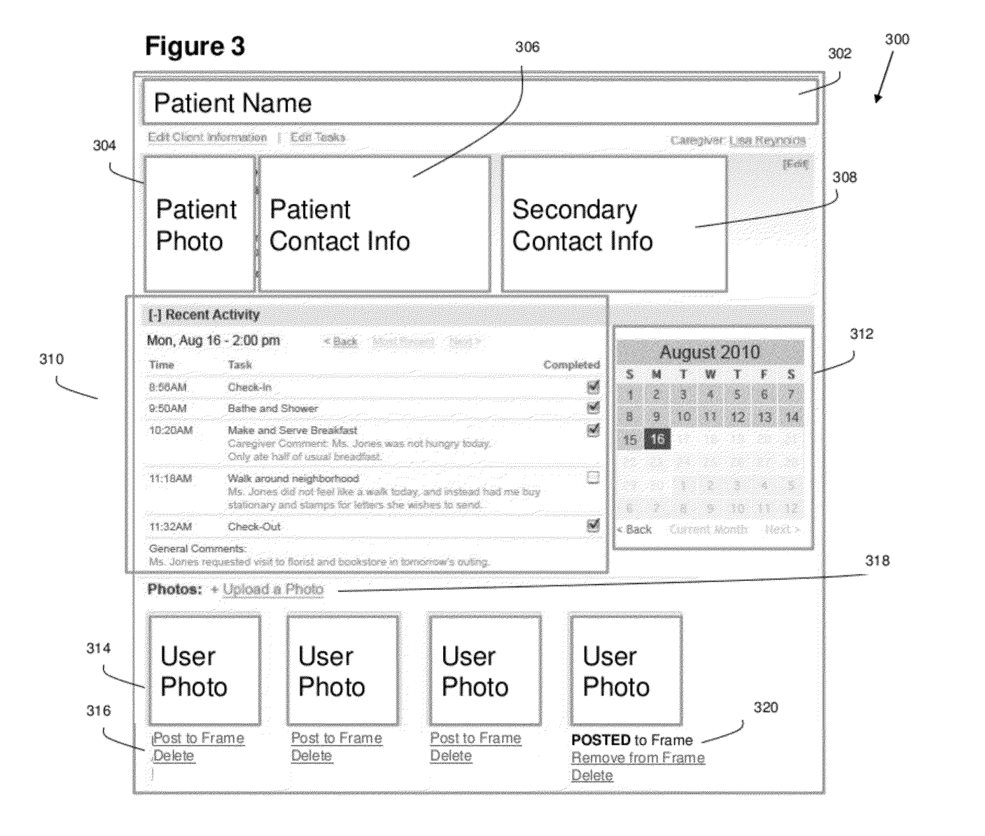

Referring to FIG. 3, a wireframe diagram illustrates one example of an interface of a web-based portal 300 for a healthcare information system that provides tracking and management of patient care, a photo storage service, and which facilitates the automatic display of photos which are transmitted via the web-based portal 300 and photo storage service to a digital picture frame. The healthcare information system provides for social connectedness between a patient and his or her family, friends, and caregivers by enabling these parties to upload photos which are displayed on the digital picture frame of the patient. In one embodiment, a touch screen tablet functioning as a digital picture frame, such as an Apple iPad, displays photos that are uploaded via the web portal 300, and also functions as a device by which one or more caregivers manages and documents care tasks at the patient point-of-care.

In another embodiment, the aforementioned touch screen tablet functioning as a digital picture frame, such as an Apple iPad™ for example, also functions as a digital camera which provides a means and channel, in addition to the web-based portal 300, by which a user may take and/or upload a photograph to the healthcare information system.

While FIG. 3 illustrates one example of an interface of a web portal 300 functioning as a healthcare information system for the management of patient care, the features illustrated herein within the context of a healthcare information system can be generalized to illustrate components of other web portals 300 such as a social networking website, wherein instead of displaying patient information and care information, the web portal 300 could show profile information and shared social information such as that displayed by social networking systems such as Facebook or MySpace. Alternatively, the web portal 300 could show photo storage service information such as is displayed by providers such as Shutterfly and SmugMug.com, or other information specific to the application in which the invention is embedded and integrated.

Element 302 illustrates a field by which identifying information of a user is displayed. In the context of a healthcare information system, this would include the patient name. Element 304 illustrates a field by which a photo of the patient is displayed. If the web portal 300 were instead illustrated in the context of a social networking website, element 304 might display a photo of the user or an image selected by a group of users in a social network (ex. a “group” in Facebook Groups). Elements 306 and 308 illustrate fields by which contact information of the patient is displayed. The reader may imagine that a variety of user or user group profile information may be displayed.

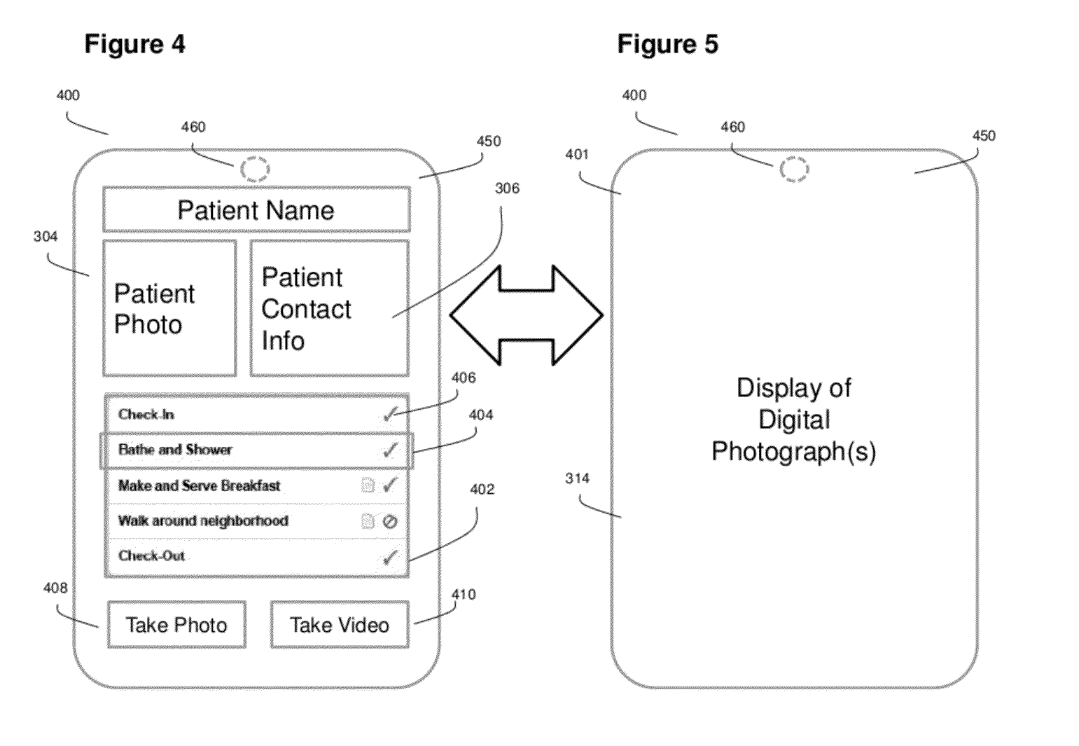

Elements 310 and 312 are in accordance with the one embodiment of the invention in which an integrated healthcare information system performs a variety of functions which may include but are not limited to: (1) tracking the completion and status of healthcare tasks, (2) enabling caregivers to provide input to the healthcare information system via a separate interface, preferably one that also serves as a digital picture frame at the patient's point of care, such as in the home, when not in use by the caregiver (see FIG. 4 and FIG. 5), and/or (3) enables the patient or family of the patient to upload pictures which are displayed in the digital picture frame when not in use by the caregiver, and/or (4) enables the patient or family of the patient to view care tasks which have been completed by a caregiver.

In one embodiment, any user of the web portal 300 must be authenticated before being able to view the web portal 300 in order to protect the confidential and private healthcare information of the patient. Means of authentication are well-known to those skilled in the art and include but are not limited to password protection and use of a personal identification number (PIN).

Element 310 illustrates a list of tasks which have been completed or are to be completed by a caregiver for the patient. As shown in the present example, the task list 310 includes a variety of information for each task, including but not limited to the time at which a caregiver completed a task and/or made an input relative to the task, a description of the task, comments submitted by the caregiver, and whether or not the task was completed. Element 312 illustrates a calendar by which tasks, including completed and incomplete tasks from past and current days, and tasks which are planned in the future, can be displayed in the task list 310 by clicking on a day in the calendar 312. Elements 310 and 312 are specific to a healthcare information system used for the management and oversight of care management plans.

In one embodiment of the invention, the system functioning as a digital picture frame, such as an Apple iPad, also functions as a device by which a caregiver manages and records the completion of tasks which are part of the care plan. According to the invention, the caregiver logs-in to the system from the point-of-care of the patient, sees the care tasks which are to be completed, and marks tasks as complete and/or enters comments as the caregiver works towards the completion of tasks. In one embodiment of the invention, the comments and completion inputs from the caregiver are transmitted via the Internet to the healthcare information system, and the completion information about the tasks and the comments are shown in element 310 when one of a variety of authorized users, such as a care administrator, the caregiver, the patient, or the family of the patient views the web portal 300. The invention thus achieves multiple benefits including transparency of care to the aforementioned parties and deepening of social connections. The invention is particularly valuable in improving the lifestyle and happiness of elderly patients receiving home healthcare from a caregiver by improving quality of care and by enabling them to view photos uploaded by their family and friends. It also helps the adult children and family of elderly patients to keep track of the delivery of care and also to share the photos with the elderly patients.

Element 318 illustrates a link to “Upload a Photo” which directs to a web-enabled interface which features an input field, a “Browse” button to find photo files on a local system, and an “Upload” button. Via these buttons and associated features, a photo file may be selected and uploaded to the healthcare information system and thereby displayed in element 314 and stored. Systems and methods for uploading a photo file over the Internet are well known to those skilled in the art. The photo 314 may thereby be subsequently displayed by the system serving as a digital picture frame, which in one embodiment also serves as an input device for caregivers.

Via this interface, family members, friends, or other persons authorized by the patient and/or caregiver are able to both monitor care and upload photos 314 for display on the digital picture frame, which displays the photos 314 when the frame is not in use by the caregiver for the provision and tracking of care (see FIG. 4 and FIG. 5). Element 316 is a pair of hyperlinks to “Post to Frame” or “Delete”, which respectively trigger functions to designate the photo 314 for download by the digital picture frame, or to delete the photo 314 from the healthcare information system. The links illustrated in element 316 are displayed when a photo 314 is displayed on the healthcare information system, but which have not been designated for download by the digital picture frame.

Element 320 illustrates the text, hyperlinks and features which are preferably displayed and enabled, respectively, when a photo 314 has been designated for display in the digital picture frame. The words “POSTED to Frame” indicate that the photo 314 has been designated for display in the digital picture frame. The “Remove from Frame” hyperlink enables the user to remove the designation that the photo 314 is to be displayed in the digital picture frame. The “Delete” hyperlink in element 316 enables the user to delete the photo 314 entirely from the healthcare information system, and thereby to also delete the photo 314 from the digital picture frame.

While the wireframe 300 illustrates a particular interface layout for a healthcare information system, one skilled in the art can anticipate many other variations which accomplish the features and benefits of the invention. Additionally, many of the elements such as 302, 304, 306, 308, 314, 316, 318 and 320 may be generalized for use of the disclosed invention in the context of a social networking website, photo sharing website, or other system.

Referring to FIG. 4 and FIG. 5, wireframe diagrams illustrate exemplary interfaces for caregivers and their patients which are part of the healthcare information system described herein, and which are preferably displayed on a touch screen tablet (ex. Apple iPad) which is used by a caregiver to manage and document care tasks, and which also functions as a digital picture frame when not in use by the caregiver or other users.

Element 400 illustrates an exemplary computer system with an interface 450, and shows one embodiment in which the computer system 400 is a touch screen computer tablet in which inputs to the computer system may be made by the user by touching the display screen interface 450, and which includes a built-in digital camera 460 which can take digital photographs that in turn can be stored, manipulated and transmitted by the computer system 400. Such computer systems 400 are well-known and are widely distributed and sold, including by way of example the Apple iPad. Element 400 illustrates the touch screen tablet in a mode in which the interface 450 is configured to be used by a caregiver as part of a healthcare information system to manage and track the completion of healthcare tasks.

FIG. 5 illustrates one example of a touch screen tablet computer system 400 in a mode in which the interface 450 is configured for the display of photos 314 in accordance with the system's 400 additional capability as a digital picture frame.

Element 402 is a list of tasks which are to be completed by the caregiver. In one embodiment of the invention, the caregiver may click or otherwise input to any individual task 404 listed to changes its status, by way of example, from “Incomplete” to “Complete.” In another embodiment, the caregiver may double-click or otherwise input to any individual task listed 404 to write one or more comments relative to the task 404. In one embodiment, each task 404 shows a completion indicator 406 which indicates the status of the task 404, and/or an indication 406 that comments have been made about the task 404, and/or an indication 406 there are detailed notes about the task 404 which may be stored on the healthcare information system, and wherein the absence of such a displayed indicator 406 can also indicate the status of a task 404. The user may appreciate that a variety of information may be provided by such an indicator 406 for each task 404.

In one embodiment, after the caregiver changes the status of one or more tasks 404 on the task list 402, the changes in the status of the one or more tasks are transmitted to the healthcare information system wherein the updated status of the tasks 404 can be displayed on the list of tasks 310 in the web portal interface illustrated in FIG. 3.

Element 408 illustrates a button which is displayed on the interface 450 which when clicked, in one embodiment, configures the system 400 and camera 460 to take a digital photograph. In one embodiment, the caregiver authenticates his or her identity upon checking-in to a patient site and/or prior to viewing tasks and/or changing the status of any tasks, such that the photo may be automatically uploaded to the healthcare information system without subsequent authentication by the caregiver.

In another embodiment, upon clicking the button 408, the caregiver is prompted by software running on the system 400 to confirm with a “yes” or “no” response whether or not the patient has given explicit permission to the caregiver for such a photograph to be taken. In another embodiment, the caregiver is prompted via the interface to physically hand the system 400 to the patient wherein the patient is instructed to authenticate his or her identity with a password or other means in order to enable a photograph to be taken and uploaded to the healthcare information system. The prompts described herein assist with compliance with healthcare laws that protect the privacy and confidential health information of patients.

In another embodiment, any photograph that is taken by the system 400 when used in conjunction with the healthcare information system, for example, by clicking the button 408, is restricted such that it is not stored on the system 400 after the caregiver logs out of the healthcare information system, and/or such that the photograph may only be stored permanently if it is transmitted over the Internet to the healthcare information system, and/or stored on the healthcare information system in a secure, remote database, wherein the photo is subsequently deleted from the device 400 after the caregiver logs-out of the present session with the device 400. Thus, photographs taken by the caregiver of the patient are restricted in circulation such that the one or more photographs can only be viewed via secure healthcare information interfaces such as illustrated in FIG. 3.

Element 410 illustrates a button that is displayed on the interface 450 that, when clicked, in one embodiment, configures the system 400 and camera 460 to take a digital video. The aforementioned functions and features for taking a photo by pressing the button 408 parallel those functions and features for taking a video by pressing the button 410, with the difference that the media file is a digital video file instead of a digital photo file in the case that button 410 is pressed.

FIG. 5 illustrates the touch screen tablet computer system 400 in a mode in which the interface 450 is configured to display one or more photos 314 in accordance with the system's 400 additional capability as a digital picture frame. This mode may be activated according to settings configured by the patient, by the caregiver, by a caregiver administrator, or by other users and/or administrators of the integrated healthcare information system, and/or may be preset in software stored on the system 400, or by other means, which are understood to those skilled in the art.

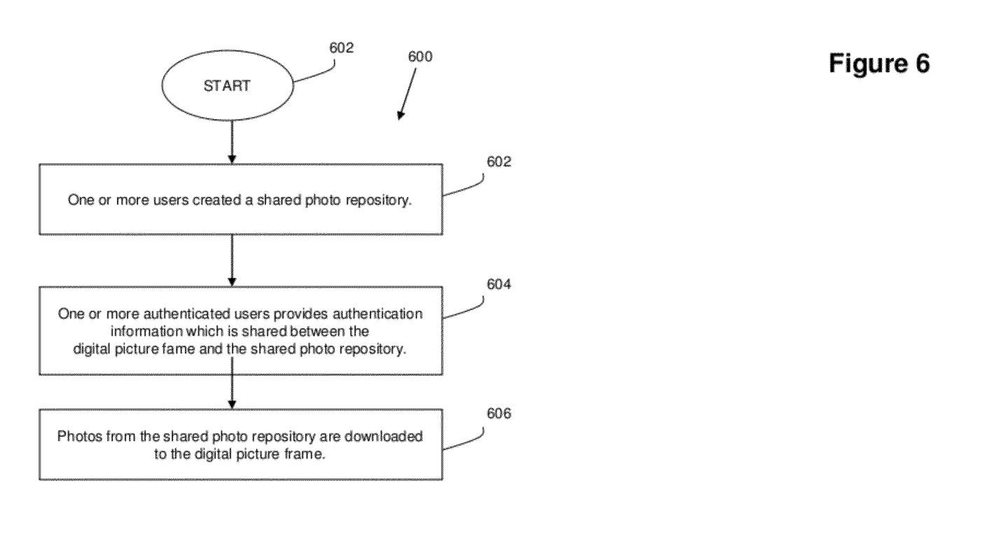

FIG. 6 is a flow diagram 600 that illustrates a computer-enabled system and apparatus for automatically displaying photos uploaded remotely to a shared photo repository to one or more digital picture frames. As described herein, a shared photo repository is a collection of one or more photos for which permissions have been defined for one or more users. By way of example, the permissions may include but are not limited to those which define which user(s) can upload photos, view photos, download photos, and/or display photos on the user(s)' digital picture frame(s).

By way of example, the permissions of a shared photo repository might be those defined by a group in a social networking website, such as Facebook Groups, by which only authenticated members of the group may perform one or more functions, such as the ability to view, upload, or download photos. By way of example, a family might create a group in “Facebook Groups” that in turn creates a shared photo repository wherein only members of the family may login and upload, view and/or download photos that have been uploaded to the Facebook Groups family website. In the present example, one or more users or devices managed by the one or more users are required to submit authentication information before performing functions associated with the photos. As illustrated by way of example, the shared photo repository is defined based on permissions that have been assigned to one or more users relative to one or more photos.

In one embodiment, one or more digital picture frames is enabled to download files from a shared photo repository using the authentication data that is used by the shared photo repository to enforce permissions. In another embodiment, the digital picture frame is configured to periodically send the authentication information via the Internet to the shared photo repository to in order to login and then subsequently determine if there exists photos that have not been downloaded from the shared repository that are designated for download to authorized digital picture frames, and if, so the digital picture frame downloads the photos. By way of example, several digital picture frames, each owned by members of a family who have established a shared photo repository, may each download some or all of the photos in the shared photo repository to their digital picture frames by configuring the digital picture frame to transmit their authentication information, such as a user name and password, to the shared photo repository. In the present example, various members of the family, including elderly grandparents who may not be technically literate, can easily view family photos in their digital picture frames because the photos are automatically downloaded from a family shared photo repository.

Looking now at flow diagram 600, starting in step 602, one or more users create a shared photo repository via means that are well known, and that are enabled by systems and methods that are well understood to those skilled in the art. The creation of the shared photo repository includes the uploading of photos to the repository and the creation of login information for various users by which users are authenticated relative to the repository.

In step 604, one or more authenticated users provide authentication information that is shared between the digital picture frame and the shared photo repository. In one embodiment, this step includes inputting the login information for the shared photo repository to the digital picture frame where it is stored on the digital picture frame. Via an application programming interface (API) with the shared photo repository, the login information is periodically transmitted over the Internet from the digital picture frame to the shared photo repository.

In step 606, after the login information is transmitted from the digital picture frame to the shared photo repository or otherwise shared between the two systems as described in step 604, photos from the shared photo repository are downloaded to the digital picture frame wherein they may subsequently displayed. In one embodiment, only those photos that have been designated for download by the digital picture frame in the shared photo repository, but that are not yet stored on the digital picture frame, are downloaded to the digital picture frame.

One embodiment of the invention as described thus allows a group of users to create a shared photo repository and to share and enjoy the photos in a digital picture frame(s) that are in possession of one or more individuals in the group. It has the benefit of being easy to use for a user who has limited technical capabilities and who owns a digital picture frame that has been configured to display photos from the shared photo repository.

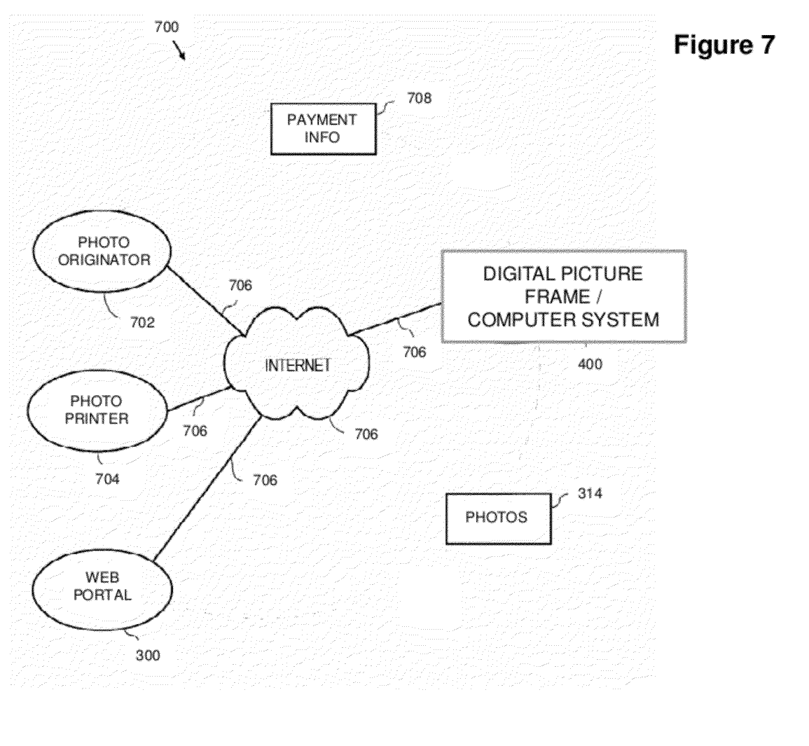

FIG. 7 is a block diagram 700 in accordance with the invention that illustrates the communication of entities via Internet connections 706 for the transmission of a variety of information including but not limited to digital photographs 314 for display on a digital picture frame 400 and/or storage on a photo storage service and/or shared photo repository accessible via a web portal 300, ordering of photos 314 for hard copy printing, and/or for the transfer of payment information 708.

In one embodiment, via a web portal 300, a photo originator 702 can upload photos 314 to a photo storage website, such as Facebook, MySpace, or Shutterfly, or to a healthcare information system accessibly via a web portal 300, to be downloaded and displayed by a computer system functioning as a digital picture frame 400. In a related embodiment of the invention, if the photo storage website accessible by web portal 300 designates permissions by which a group has access to photographs 314 and other shared materials and information that are otherwise not accessible by users that are not members of the group (by way of example, “Facebook Groups”), the aforementioned group permissions can be used to determine which users can download and display digital pictures 314 to their digital picture frame(s) 400 in accordance with the invention.

In another embodiment, a photo 314 may be purchased from the computer system functioning as a digital picture frame 400. In one embodiment, a user may touch the screen of a digital picture frame 400 when it displays a photo 314, and this event triggers the display of a purchase interface on the computer system functioning as a digital picture frame 400 that enables the user to order a printed hard copy of the photo 314. In another embodiment, purchasing and payment information 708 including but not limited to the user's shipping address, payment means, billing address, and other data is stored and is transmitted in the event that a user makes a request via the digital picture frame 400 for purchase of one or more photos. The purchasing and payment information 708 is transmitted to the photo storage service accessible by web portal 300, and in turn triggers a purchase and a series of steps well-known to those skilled in the art to fulfill the purchase of hard copies of the one or more photos 314.

In another embodiment, payment is distributed to one or more parties when a photo 314 is purchased from the computer system functioning as a digital picture frame 400 in accordance with the payment information 708. The one or more parties to which payment is distributed may include but are not limited to the provider of the photo storage website accessible by web portal 300, such as Facebook or Shutterfly, the provider of software that enables photos to be downloaded by the computer functioning as a digital picture frame 400 and/or that enables ordering of photos via the digital picture frame 400, and/or a printing and fulfillment company(s) that prints and/or ships the photos.

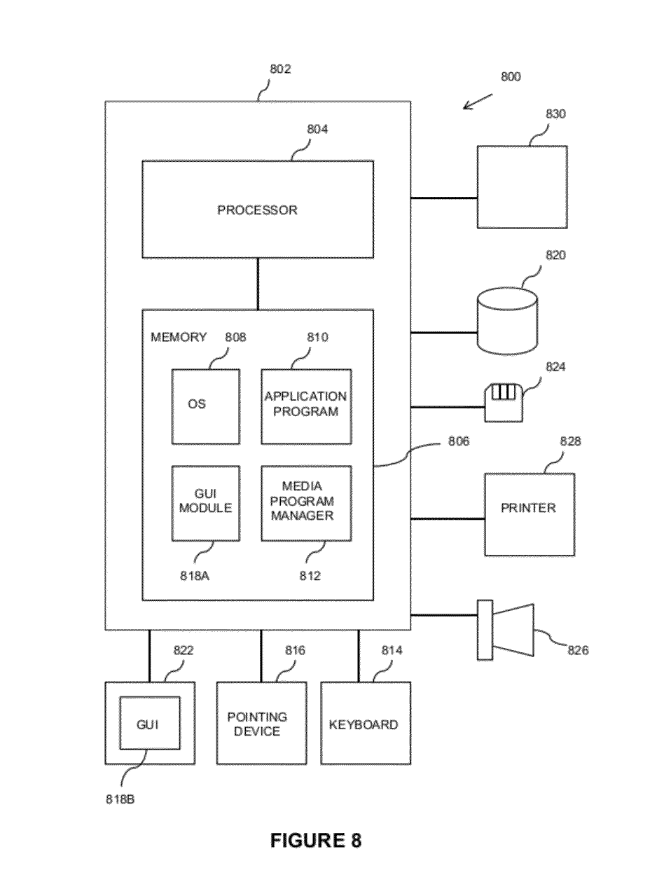

Referring to FIG. 8, an example of a computer device configured with a media program manager is illustrated. Such a device may be configured with an interface program for sending media programs such as photos and video to remote display devices according to embodiments described herein. The device 800 may include a computer 802 having a processor 804 configured to process software code and data stored in memory 806 to perform operations of the system, sending media programs to remote display devices for example. The memory device may include operating system (OS) code 808 for running the computer's operating system and application program 810 for running applications on the computer. A media program manager 812 may include code configured to manage media programs such as photos and videos for operating as an interface for sending to a remote display device via a network. The system may include a keyboard 814 that may be a peripheral device or may be integrated in the computer, such as a tablet computer. A pointing device such as a mouse or integrated touch screen 816 may be included for selecting objects on the screen of the computer. A visual display 822 may include a graphical user interface (GUI) 818B that is operated by the computer by processing code located in the GUI module 818A in memory. Remote storage or database 820 or disk reader 824 may be in communication with the computer 802 for extra or portable storage capacity. Speaker 826 may be included for audio sounds for a user, and a printer 828 may be further included for printing documents or displayed items. Other components 830 may be included for communication or operation with the computer, such as a communication modem, network interface, USB interface, or other devices well known in the art for communicating and operating with a computer such as 802.

As discussed herein, the invention may involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet-related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and also possibly computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state. The invention is not limited to any particular type of memory device, or any commonly used protocol for storing and retrieving information to and from these memory devices, respectively.

Embodiments of the systems and methods described herein facilitate the management of data sent to and from a digital photo or video display. Additionally, some embodiments may be used in conjunction with one or more conventional data management systems and methods, or conventional virtualized systems. For example, one embodiment may be used as an improvement of existing data management systems for displaying video or photos on portable devices.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Finally, although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A machine readable medium containing instructions that, when executed by one or more processors, perform operations comprising:
providing an interface to a remote digital display device having a visual display, an device processor and memory configured to display one or more media programs for viewing on the digital display device;
sending a media program from another location with the interface via a computer network system to automatically display on the remote display device with the device processor and memory.

2. A medium according to claim 1, wherein the remote display device includes a display application configured to display received photos on the visual display.

3. A medium according to claim 1, wherein the remote display device includes a display application configured to display received photos on a screen saver application configured to display media programs on the visual display when it is not in use by a user.

4. A medium according to claim 3, media program includes one of photos, advertisements and video programs.

5. A system for displaying digital photos on a digital picture frame used for the management of healthcare comprising:
a portable display device configured for the display of digital media programs and for the management of healthcare;
a computing device configured to communicate with the portable display device having an interface by which photos may be designated for transmission to the display device.

6. A system according to claim 5, wherein the portable display device includes a display application configured to display received photos on the visual display.

7. A system according to claim 5, wherein the remote display device includes a display application configured to display received photos on a screen saver application configured to display media programs on the visual display when it is not in use by a user.

8. A system according to claim 7, wherein the media program includes one of photos, advertisements and video programs.
